(19) United States
(12) Patent Application Publication
(10) Pub. No.: US 2010/0162127 A1
(43) Pub. Date: Jun. 24, 2010

(54) INFORMATION PROCESSING SYSTEM AND DISPLAY CONTROL METHOD

(75) Inventor: Satoshi Uchino, Koganei-shi (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/558,478

(22) Filed: Sep. 11, 2009

(30) Foreign Application Priority Data
Dec. 22, 2008 (JP) 2008-326229

(51) Int. Cl. G06F 3/048

(52) U.S. Cl. 715/740

(57) ABSTRACT

According to one embodiment, an information processing system includes at least one remote apparatus and a local terminal connected to the at least one remote apparatus via a network. The at least one remote apparatus transmits a screen image on which objects are drawn, and drawing region data which indicates a region on the screen image where each of the objects is drawn. The local terminal receives the screen image and the drawing region data from the at least one remote apparatus, extracts images corresponding to the objects from the received screen image based on the received drawing region data, and displays the extracted images of the objects on a display screen.

### CROSS-REFERENCE TO RELATED APPLICATIONS

This application is based upon and claims the benefit of priority from Japanese Patent Application No. 2008-326229, filed Dec. 22, 2008, the entire contents of which are incorporated herein by reference.

### BACKGROUND

1. Field

One embodiment of the invention relates to an information processing system having a display control function like a remote desktop.

2. Description of the Related Art

As one remote control method of controlling a remote terminal from a local terminal, a method of transmitting screen data from a remote terminal to a local terminal, and transmitting a control signal that updates the screen data from the local terminal to the remote terminal is used. For example, Windows XP™ as an OS provided by Microsoft Corporation has a function called a remote desktop system that displays a screen image displayed on the screen of the remote terminal on that of the local screen, and allows the local terminal to manipulate an object on the screen image of the remote terminal.

Jpn. Pat. Appln. KOKAI Publication No. 2007-86354 discloses a composite video control apparatus which generates a composite video by compositing individual videos received from video providing apparatuses, and can transmit a manipulation instruction to the composite video to the video providing apparatus as a source of the individual video corresponding to a manipulation instruction position.

In the composite video control apparatus disclosed in Jpn. Pat. Appln. KOKAI Publication No. 2007-86354, individual videos included in the composite video are managed for respective video providing apparatuses. Therefore, the manipulation instruction is issued for each individual video, but a manipulation and control cannot be made by designating a partial region in the individual video.

In the remote desktop system, screen data is managed for each remote terminal, and when there are a plurality of remote terminals, the local terminal manipulates and controls the screen image generated for each remote terminal. In the remote desktop system, the full screen image of the remote terminal is transmitted to the local terminal, and is displayed as a remote desktop screen on the display screen of the local terminal. In this case, on the local terminal, the full screen image from a certain remote terminal is allocated on one layer. For this reason, when the screen image transmitted from the remote terminal includes objects such as windows, all these objects are allocated on the same layer. Therefore, the layout such as the position and size of the remote desktop screen on the display screen of the local terminal can be changed in that full screen unit, but it is difficult to change the layouts of individual objects such as windows on the remote desktop screen unless the screen image transmitted from the remote terminal is updated. Also, it is difficult to sandwich, e.g., a window on the desktop of the local terminal or a window included in the screen image from another remote terminal between objects on the remote desktop screen and to display them to overlap each other.

For this reason, a novel function that can handle screen data transmitted from a remote terminal for respective objects is demanded to be implemented.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the arrangement of an information processing system according to an embodiment of the invention;

FIG. 2 is an exemplary view showing an example of layers generated by the information processing system according to the embodiment;

FIG. 3 is an exemplary view showing an example of layers generated from screen images of remote terminals by the information processing system according to the embodiment;

FIG. 4 is an exemplary view showing an example of a screen display on a local terminal by the information processing system according to the embodiment;

FIG. 5 is an exemplary flowchart showing the procedure of remote desktop connection processing between a local terminal and remote terminal in the information processing system according to the embodiment;

FIG. 6 is an exemplary flowchart showing the procedure of transmission processing by a remote terminal in the information processing system according to the embodiment;

FIG. 7 is an exemplary flowchart showing the procedure of reception processing by a local terminal in the information processing system according to the embodiment;

FIG. 8 is an exemplary flowchart showing the procedure of transmission processing by a local terminal in the information processing system according to the embodiment;

FIG. 9 is an exemplary flowchart showing the procedure of reception processing by a remote terminal in the information processing system according to the embodiment; and

FIG. 10 is an exemplary view showing another example of layers generated by the information processing system according to the embodiment.

### DETAILED DESCRIPTION

Various embodiments according to the invention will be described hereinafter with reference to the accompanying drawings. In general, according to one embodiment of the invention, there is provided an information processing system comprising: at least one remote apparatus configured to transmit a screen image on which objects are drawn, and drawing region data which indicates a region on the screen image where each of the objects is drawn; and a local terminal connected to the at least one remote apparatus via a network and configured to receive the screen image and the drawing region data from the at least one remote apparatus, to extract images corresponding to the objects from the received screen image based on the received drawing region data, and to display the extracted images of the objects on a display screen.

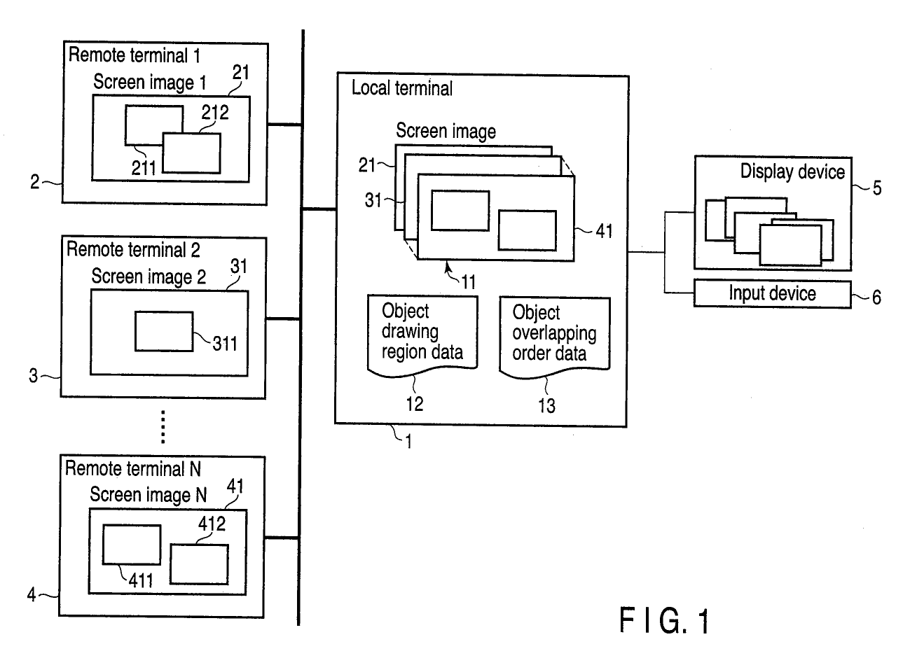

The arrangement of an information processing system according to an embodiment of the invention will be described first with reference to FIG. 1.

This information processing system includes a local terminal 1 and remote terminals (a remote terminal 2, remote terminal 3, and remote terminal 4) located at remote sites. The local terminal 1, remote terminal 2, remote terminal 3, and remote terminal 4 are respectively information processing apparatuses such as personal computers each of which includes a GUI using a window system. The local terminal 1, remote terminal 2, remote terminal 3, and remote terminal 4 are connected to each other via a network such as Ethernet™.

The remote terminal 2, remote terminal 3, and remote terminal 4 respectively hold a screen image 21, screen image 31, and screen image 41. The screen image 21, screen image 31, and screen image 41 are normally respectively displayed on display devices provided to the remote terminal 2, remote terminal 3, and remote terminal 4. Note that the remote terminal 2, remote terminal 3, and remote terminal 4 may be those which include neither a display device nor an input device.

On the screen image 21 of the remote terminal 2, objects 211 and 212 are drawn. On the screen image 31 of the remote terminal 3, an object 311 is drawn. On the screen image 41 of the remote terminal 4, objects 411 and 412 are drawn.

Each object is, for example, a window of an application program. That is, the object 211 as a window of a word processing program, and the object 212 as a window of a spreadsheet program, for example, are drawn on the screen image 21 of the remote terminal 2. Also, a graphics image such as a clock or calendar may be drawn on the screen image 21 as an object.

The remote terminal 2 transmits, to the local terminal 1, the screen image 21, drawing region data of each of the objects 211 and 212, and overlapping order data of the objects 211 and 211. The drawing region data of each object represents a region on the screen image where that object is drawn. Therefore, the drawing region data of the object describes the shape, size, position, and the like of an object drawn on the screen image. Also, the overlapping order data of objects describes the drawing order of objects on the screen image.

Likewise, the remote terminal 3 transmits, to the local terminal 1, the screen image 31, drawing region data of the object 311, and overlapping order data of the object 311.

The remote terminal 4 similarly transmits, to the local terminal 1, the screen image 41, drawing region data of each of the objects 411 and 412, and overlapping order data of the objects 411 and 412.

In the following description, the screen image, drawing region data of an object, and overlapping order data of objects will be referred to as screen data. This screen data is encoded in an arbitrary format in each remote terminal, and is transmitted from the remote terminal to the local terminal. The screen image of the screen data can be exchanged based on a protocol used in, for example, a system called a remote desktop or thin client such as Virtual Network Computing (VNC) or Remote Desktop Protocol (RDP). Such a protocol will be referred to as a thin-client protocol hereinafter.

The local terminal 1 holds a screen image 11, object drawing region data 12, and object overlapping order data 13, which are obtained by integrating the items of screen data received from the remote terminal 2, remote terminal 3, and remote terminal 4. The screen image 11 includes the screen image 21, screen image 31, and screen image 41 respectively received from the remote terminals. That is, the screen image 21 held by the remote terminal 2 is managed to match the corresponding screen image in the screen image 11 held by the local terminal 1. Also, the screen image 31 held by the remote terminal 3 is managed to match the corresponding screen image in the screen image 11 held by the local terminal 1. Furthermore, the screen image 41 held by the remote terminal 4 is managed to match the corresponding screen image in the screen image 11 held by the local terminal 1. The object drawing region data 12 includes items of object drawing region data respectively received from the remote terminals. The object overlapping order data 13 includes items of object overlapping order data respectively received from the remote terminals.

The local terminal 1 generates layers for respective objects using the items of screen data received from the remote terminals. On each layer, an image corresponding to each object extracted from the screen image is drawn. The local terminal 1 manages displays and manipulations of objects for respective objects by generating layers for respective objects.

To the local terminal 1, a display device 5 as a screen used to present information to the user, and an input device 6 used to input user's instructions are connected.

The display device 5 includes, for example, an LCD. The display device 5 displays, on the screen, layers displayed on a desktop screen of the local terminal 1, and those generated based on items of screen data received from the respective remote terminals to overlap each other.

The input device 6 includes, for example, a keyboard and a mouse. The user manipulates an object on an image displayed on the screen as the display device 5 using the keyboard and the mouse as the input device 6. The user can freely change the layouts of objects using the input device 6, and can change, for example, the overlapping order of objects. More specifically, the user inputs an instruction to move a certain object to the frontmost position of objects.

Manipulation data of an object on the local terminal 1 is transmitted to the remote terminal corresponding to the manipulated object (focused object). Therefore, the local terminal 1 manages focus data indicating which object is focused. The object manipulation data can be exchanged based on the aforementioned thin-client protocol. Upon reception of the object manipulation data, the remote terminal updates screen data such as the screen image based on the received data.

Note that the display device 5 and input device 6 are connected to the local terminal 1. However, display devices and input devices need not always be connected to the remote terminal 2, remote terminal 3, and remote terminal 4.

The remote terminal 2, remote terminal 3, and remote terminal 4 transmit items of object drawing region data to the local terminal 1, as described above.

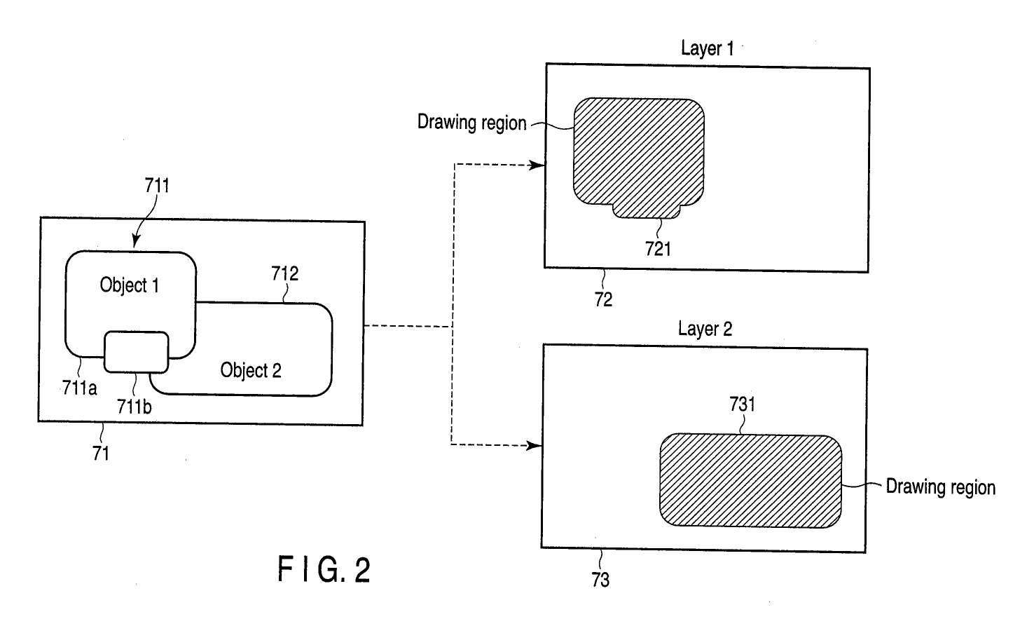

Drawing regions set for respective objects in the screen image will be described below with reference to FIG. 2. FIG. 2 shows drawing regions respectively corresponding to objects 711 and 712 drawn on a screen image 71 of a certain remote terminal.

Referring to FIG. 2, the objects 711 and 712 are drawn on the screen image 71. The object 711 includes sub-objects 711a and 711b. The object 711 combines, as one object, a parent window and its child window like a modal window in Windows™, an OS produced by Microsoft Corporation. Therefore, for example, the sub-object 711a as a window of an application program, the sub-object 711b as a dialog, and the object 712 as a window of another application program are drawn on the screen image 71. Even windows which belong to an identical application program but which can be allocated in an arbitrary overlapping order may be handled as independent objects.

A drawing region is set for each object as a region which contains the object. Therefore, a drawing region corresponding to the object 711 is a drawing region 721 that contains the sub-objects 711a and 711b. Also, a drawing region corresponding to the object 712 is a drawing region 731 that contains the object 712.

An arbitrary shape can be set as a drawing region, which may be a region of any shape such as a rectangular region that contains an object, a set of rectangular regions, a circular region, and a polygonal region.

Respective remote terminals transmit, to the local terminal 1, the screen images and items of object overlapping order data in addition to items of object drawing region data each of which describes the shape, size, position, and the like of a drawing region, as described above. The local terminal 1 generates layers using these items of received screen data. For example, the local terminal 1 extracts images of objects from the screen image 21 received from the remote terminal 2 based on the items of object drawing region data received from the remote terminal 2. The local terminal 1 draws the extracted images of the objects on different layers. The local terminal 1 overlays the layers on the display screen in the overlapping order indicated by the overlapping order data received from the remote terminal 2.

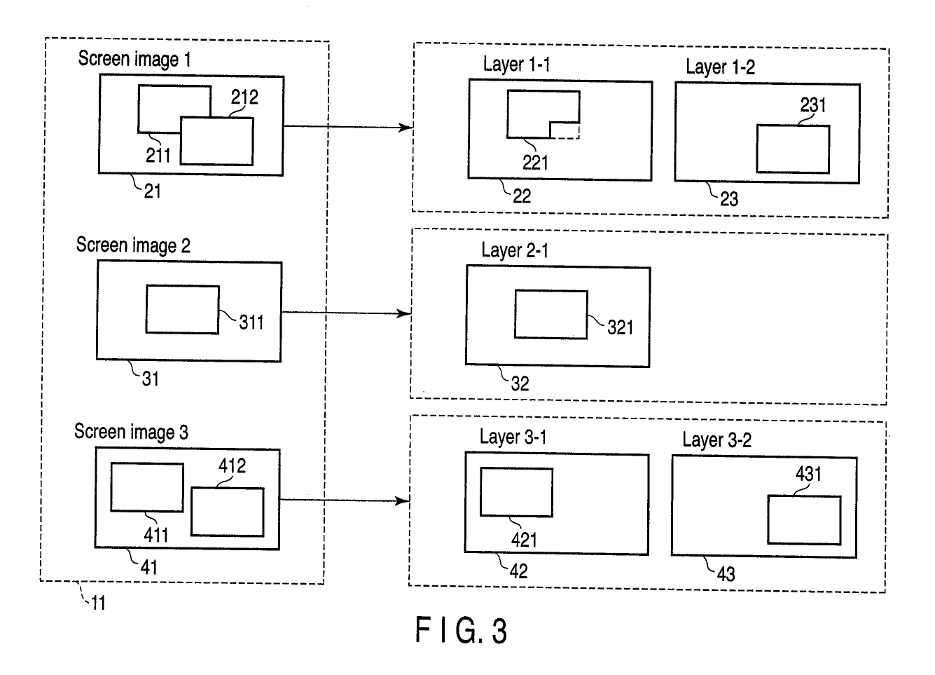

FIG. 3 shows an example of layers generated using the screen image 11, object drawing region data 12, and object overlapping order data 13 in the local terminal 1. Each layer has the same size as the screen image. On each layer, an image corresponding to an object extracted from the screen image based on the object drawing region data is drawn. A region of the layer except for the drawing region of an object, i.e., a background part of the layer, has transparency.

The local terminal 1 extracts object images as images corresponding to respective objects from the screen image 21, screen image 31, and screen image 41 respectively transmitted from the remote terminal 2, remote terminal 3, and remote terminal 4 based on the object drawing region data 12 and object overlapping order data 13. For example, the local terminal 1 extracts object images respectively corresponding to objects from the screen image 21 transmitted from the remote terminal 2 based on data which is received from the remote terminal 2 and included in the object drawing region data 12 and object overlapping order data 13. Then, the local terminal 1 generates layers on which the extracted object images are drawn and which have transparent backgrounds.

Therefore, in FIG. 3, the local terminal 1 extracts an object image 221 corresponding to the object 211 and an object image 231 corresponding to the object 212 from the screen image 21. On the screen image 21, since the object 211 is drawn below the object 212, a part of the object 211 is occluded behind the object 212. The local terminal 1 extracts the object images 221 and 231 from the screen image 21 based on data which is received from the remote terminal 2 and included in the object drawing region data 12 and object overlapping order data from the remote terminal 2, in consideration of the occlusion relationship between the objects 211 and 212. Therefore, the local terminal 1 extracts the object image 221 corresponding to a drawing region excluding a region occluded behind the object 212 in correspondence with the object 211. Since the object 212 has no region occluded behind another object, the object image 231 corresponding to the entire drawing region of the object 212 is extracted.

Then, the local terminal 1 generates a layer 22 on which the extracted object image 221 is drawn, and a layer 23 on which the extracted object image 231 is drawn. That is, the screen image 21 of the remote terminal 2, which includes the objects 211 and 212, is shared by the layers 22 and 23.

Likewise, the local terminal 1 extracts an object image 321 corresponding to the object 311 from the screen image 31. Then, the local terminal 1 generates a layer 32 on which the extracted object image 321 is drawn.

Also, the local terminal 1 extracts an object image 421 corresponding to the object 411 and an object image 431 corresponding to the object 412 from the screen image 41. Then, the local terminal 1 generates a layer 42 on which the extracted object image 421 is drawn, and a layer 43 on which the extracted object image 431 is drawn.

With the aforementioned layer generation processing, layers on which the object images of the respective objects are drawn are generated based on the screen image 11, object drawing region data 12, and object overlapping order data 13.

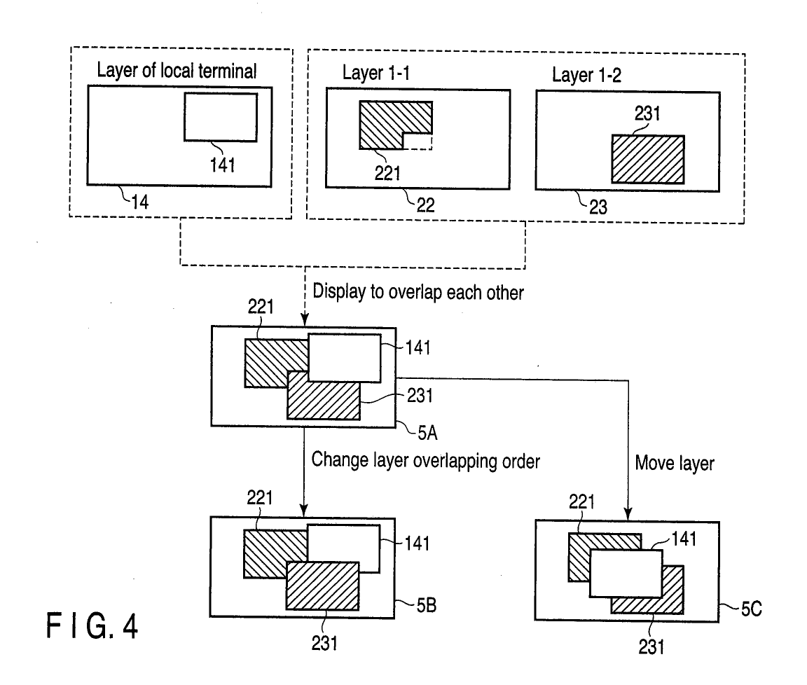

The local terminal 1 displays the generated layers on a display screen 5A of the display device 5 to overlap each other. FIG. 4 shows an example of layers displayed on the display device 5.

In this case, assume that a layer 14 is displayed on the local terminal 1, and the layers 22 and 23 are also displayed on this screen to overlap each other based on the screen image 21 transmitted from the remote terminal 2, the object drawing region data 12, and the object overlapping order data 13. Note that the layer 14 is that displayed on the desktop screen of the local terminal 1. Therefore, for example, the layer 14 is that on which a window generated by an OS or application program of the local terminal 1 is drawn as an object. On the layers 14, 22, and 23, an object image 141, the object image 221, and the object image 231 are respectively drawn, and their backgrounds are set to be transparent.

The local terminal 1 displays the layers 14, 22, and 23 on the display screen 5A to overlap each other. The layers 22 and 23 are overlaid based on the object overlapping order data 13. Therefore, the object images 141, 231, and 221 are displayed to overlap each other on the display screen 5A in turn from the front side. Note that the overlapping relationship between layers of the local terminal 1 and those of each remote terminal can be appropriately set. For example, the layers of the local terminal 1 are displayed in front of those of each remote terminal, the connection order of the remote terminals is used as the overlapping order of the layers of the remote terminals, or the user arbitrarily decides the overlapping relationship.

The user can manipulate respective layers (respective object images) using the input device 6. For example, the user can change the overlapping order of layers or can move each layer by manipulations using the keyboard and the mouse as the input device 6.

Upon changing the overlapping order of layers, the user clicks an object image using, e.g., the mouse. When the user clicks the object image 231, the object image 231 (layer 23) is displayed at the frontmost position. That is, the object images 231, 141, and 221 are displayed to overlap each other on a display screen 5B in turn from the front side.

Upon moving a layer, the user drags an object image using, e.g., the mouse. When the user drags the object image 141, the object image 141 is moved to a position designated by dragging. On a display screen 5C, the object image 141 which was located at the upper right position on the display screen 5A is moved to the center of the screen. The user can similarly move the object image 221 and object image 231 by dragging.

The local terminal 1 independently manages objects to be displayed on the screen using independent layers. For this reason, the local terminal 1 can display the layer 14 of the local terminal to be sandwiched between the layers 22 and 23 generated based on the screen data of the remote terminal 2, as shown in the display screen 5B. That is, on the local terminal 1, the user can freely manipulate objects of the local terminal 1 and those of the remote terminals with no distinction.

When the user manipulates an object using the input device 6, the local terminal 1 transmits input data by this manipulation to the remote terminal corresponding to the manipulated object. The remote terminal updates the screen image based on the received input data. The remote terminal then transmits, to the local terminal 1, the updated screen image, and the object drawing region data and object overlapping order data based on the updated screen image. Note that the updated screen image, and the object drawing region data and object overlapping order data based on the updated screen image may be difference data from the already transmitted data. That is, for example, the remote terminal transmits, to the local terminal 1, a difference between the previously transmitted screen image and the updated screen image to be currently transmitted.

The local terminal 1 updates the layers based on the received screen data. Then, the local terminal 1 re-draws the screen of the display device 5 using the updated layers. That is, the local terminal 1 receives the changed screen image, and the object drawing region data and object overlapping order data based on the changed screen image, and extracts images respectively corresponding to objects from the received screen image based on the received object drawing region data. Then, the local terminal 1 displays layers, on which the extracted images of the objects are drawn on the display screen, based on the received object overlapping order data.

Therefore, for example, when the user displays the object image 221 at the frontmost position by clicking the object image 221 drawn on the display screen SA using the mouse, the overlapping order of object images has to be changed, and a region of the object image 221 occluded behind the object image 231 has to be drawn. In this case, the local terminal 1 transmits input data by the mouse to the remote terminal 2. The remote terminal 2 updates the screen image 21 based on the received input data, and draws the overall object 211, which was partially occluded behind the object 212. The remote terminal 2 transmits, to the local terminal 1, the updated screen image 21, and the object drawing region data and object overlapping order data based on the updated screen image 21. When the local terminal 1 updates the screen displayed on the display device 5 based on the received screen data, the overall object image 221, which was partially occluded behind the object image 231, is drawn.

That is, the local terminal 1 transmits object manipulation data to the remote terminal, and the remote terminal transmits the screen image updated using the object manipulation data to the local terminal, thereby updating the layers (object images) to be displayed on the display device 5 of the local terminal 1.

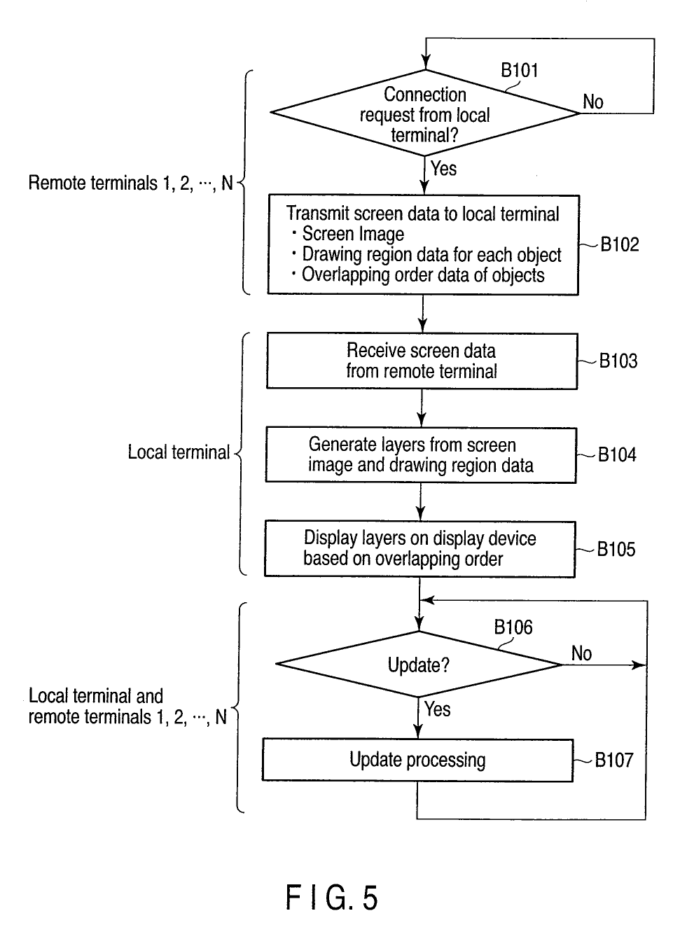

FIG. 5 is a flowchart showing the procedure of remote desktop connection processing between the local terminal 1 and remote terminals.

Each remote terminal determines if a remote desktop connection request is received from the local terminal 1 (block B101). For example, the user issues the remote desktop connection request from the local terminal 1 to the remote terminal.

If the remote desktop connection request to the remote terminal is received from the local terminal 1 (YES in block B101), the remote terminal transmits screen data to the local terminal 1 (block B102). The screen data includes the screen image, drawing region data for each object, and object overlapping order data in the remote terminal.

The local terminal 1 receives the screen data transmitted from the remote terminal (block B103). The local terminal 1 generates layers using the received screen data (block B104). The local terminal 1 extracts an image corresponding to each object from the screen image based on the drawing region data for each object, and generates a layer on which the extracted image is drawn. The local terminal 1 displays the generated layers on the display screen of the display device 5 based on the overlapping order data (block B105). That is, in block B105 the local terminal 1 overlays the generated layers on the display screen of the display device 5 in the order indicated by the overlapping order data.

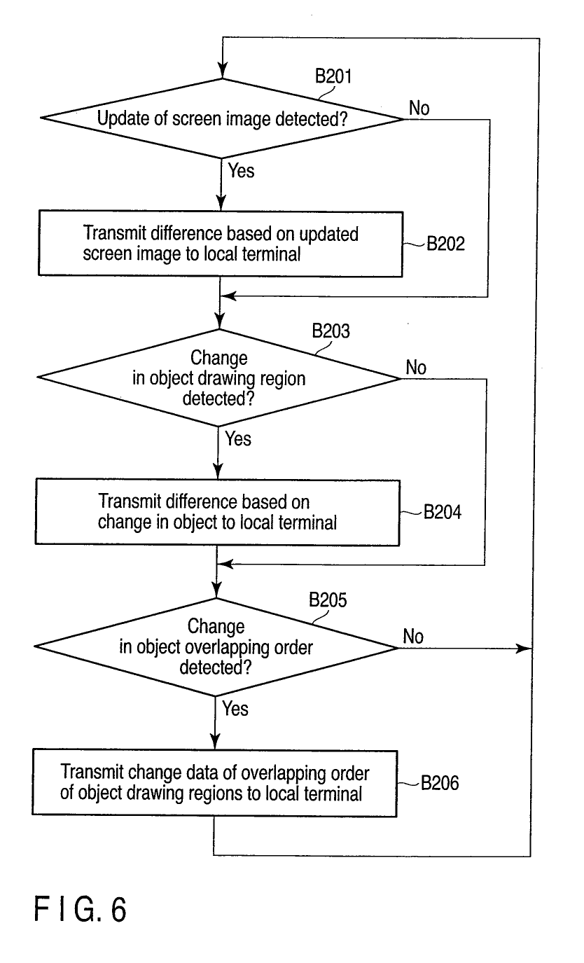

Each of the local terminal 1 and remote terminal determines if the screen data is updated in the terminal (block B106). If the screen data is updated (YES in block B106), the local terminal 1 or remote terminal, whose screen data is updated, executes processing according to updating (block B107). This update processing will be described later with reference to FIGS. 6, 7, 8, and 9.

With the aforementioned processing, the local terminal 1 and remote terminal establish a remote desktop connection, and can exchange screen data in these terminals.

FIG. 6 is a flowchart showing the procedure of transmission processing by the remote terminal.

The remote terminal determines if the screen image is updated (block B201). The screen image of the remote terminal is updated, for example, when control data is received from the local terminal. If the screen image is updated (YES in block B201), the remote terminal transmits a difference between the updated screen image and that before updating to the local terminal 1 (block B202).

If the screen image is not updated (NO in block B201), or after execution of the transmission processing in block B202, the remote terminal determines if a change in object drawing region is detected (block B203). If a change in object drawing region is detected (YES in block B203), the remote terminal transmits data of a difference between the changed object drawing region and that before change to the local terminal 1 (block B204).

If no object drawing region is updated (NO in block B203), or after execution of the transmission processing in block B204, the remote terminal determines if a change in object overlapping order is detected (block B205). If a change in object overlapping order is detected (YES in block B205), the remote terminal transmits the changed object overlapping order data to the local terminal 1 (block B206).

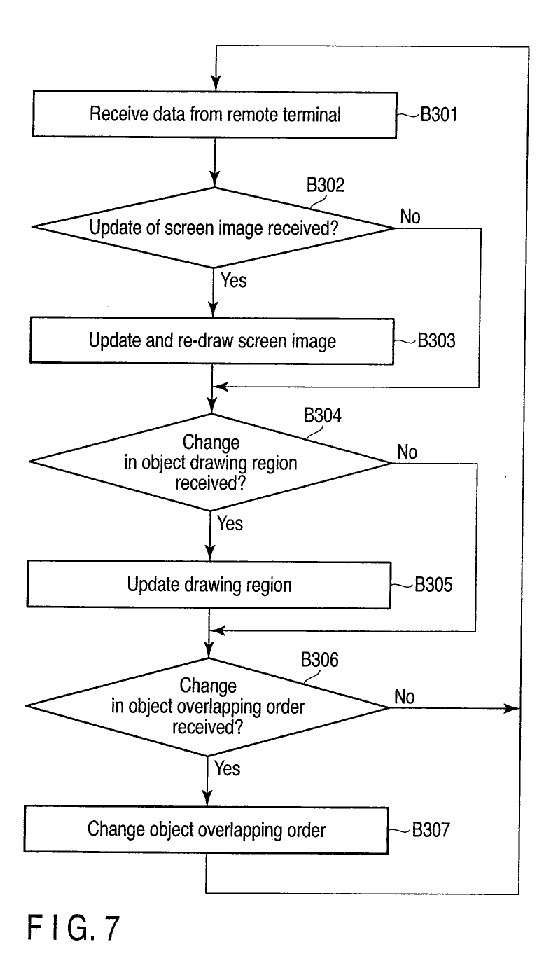

The local terminal 1 receives the screen data transmitted from the remote terminal by the aforementioned processing, and executes reception processing according to the screen data. FIG. 7 is a flowchart showing the procedure of the reception processing by the local terminal 1.

The local terminal 1 receives data as the screen data (block B301). The local terminal 1 determines if the received data is update data of the screen image (block B302).

If the received data is update data of the screen image (YES in block B302), the local terminal 1 updates the screen image held in itself (block B303). Since the received update data of the screen image is difference data between the screen images before and after updating, the local terminal 1 generates the current screen image using the screen image held in itself and this difference data.

If the received data is not update data of the screen image (NO in block B302), or after execution of the update processing of the screen image in block B303, the local terminal 1 determines if the received data is change data of an object drawing region (block B304). If the received data is change data of an object drawing region (YES in block B304), the local terminal 1 updates the object drawing region data held in itself (block B305). Since the received change data of an object drawing region is difference data between the changed object drawing region data and that before change, the local terminal 1 generates the current object drawing region data using the object drawing region data held in itself and this difference data.

If the received data is not change data of an object drawing region (NO in block B304), or after execution of the change processing of an object drawing region in block B305, the local terminal 1 determines if the received data is change data of the object overlapping order (block B306). If the received data is change data of the object overlapping order (YES in block B306), the local terminal 1 updates the object overlapping order data held in itself (block B307).

With the aforementioned reception processing, the screen image 11, object drawing region data 12, and object overlapping order data 13 held in the local terminal 1 are updated. The local terminal 1 updates layers using these items of updated data, and re-draws the updated layers on the screen of the display device 5.

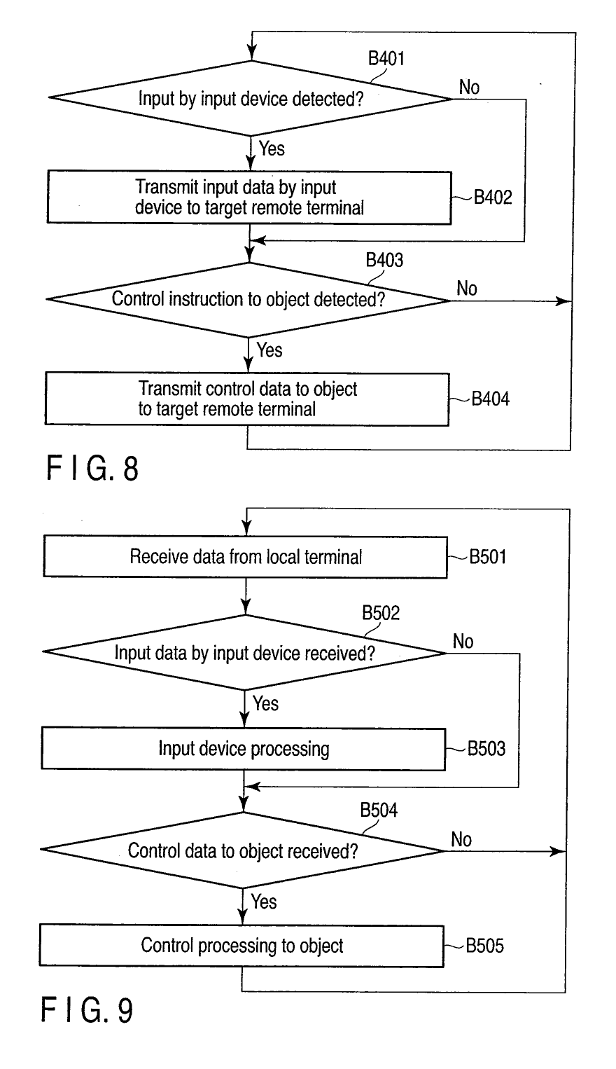

On the local terminal 1, the user manipulates an object displayed on the screen of the display device 5 using the input device 6. When the user manipulates an object on a layer generated from the screen data of the remote terminal, the local terminal 1 executes processing for transmitting the manipulation data to that remote terminal. FIG. 8 is a flowchart showing the procedure of the transmission processing by the local terminal 1.

The local terminal 1 determines if a manipulation input of an object using the input device 6 is detected (block B401). If the manipulation input of an object using the input device 6 is detected (YES in block B401), the local terminal 1 transmits input data to the remote terminal corresponding to the object manipulated by this input (block B402). The input data indicates manipulation data of an object manipulated by the keyboard or the mouse as the input device 6 connected to the local terminal 1.

If no manipulation input of an object using the input device 6 is detected (NO in block B401), or after execution of the transmission processing of input data to the remote terminal in block B402, the local terminal 1 determines if a control instruction to an object is detected (block B403). The control instruction to an object is issued by an OS or application program. This control instruction is issued by a manipulation to a region other than objects on the display screen such as a manipulation to a task bar on the display screen using the input device 6. If the control instruction to an object is detected (YES in block B403), the local terminal 1 transmits control data to the remote terminal corresponding to the object to which the control instruction is issued (block B404). The control data indicates manipulation data of the object manipulated by the aforementioned control instruction.

The remote terminal receives input data or control data transmitted from the local terminal 1 by the aforementioned processing, and executes reception processing according to the received data. FIG. 9 is a flowchart showing the procedure of the reception processing by the remote terminal.

The remote terminal receives data as input data or control data (block B501). The remote terminal determines if the received data is input data using the input device 6 (block B502). If the received data is input data (YES in block B502), the remote terminal updates the screen image held in itself in accordance with the input data (block B503).

If the received data is not input data (NO in block B502), or after execution of the update processing of the screen image in block B503, the remote terminal determines if the received data is control data of an object (block B504). If the received data is control data of an object (YES in block B504), the remote terminal controls its object according to the control data (block B505).

With the aforementioned reception processing, the screen image held in the remote terminal is updated, and the remote terminal transmits, to the local terminal 1, the updated screen image, and the object drawing region data and object overlapping order data based on the updated screen image, in accordance with the procedure of the transmission processing shown in the flowchart of FIG. 6.

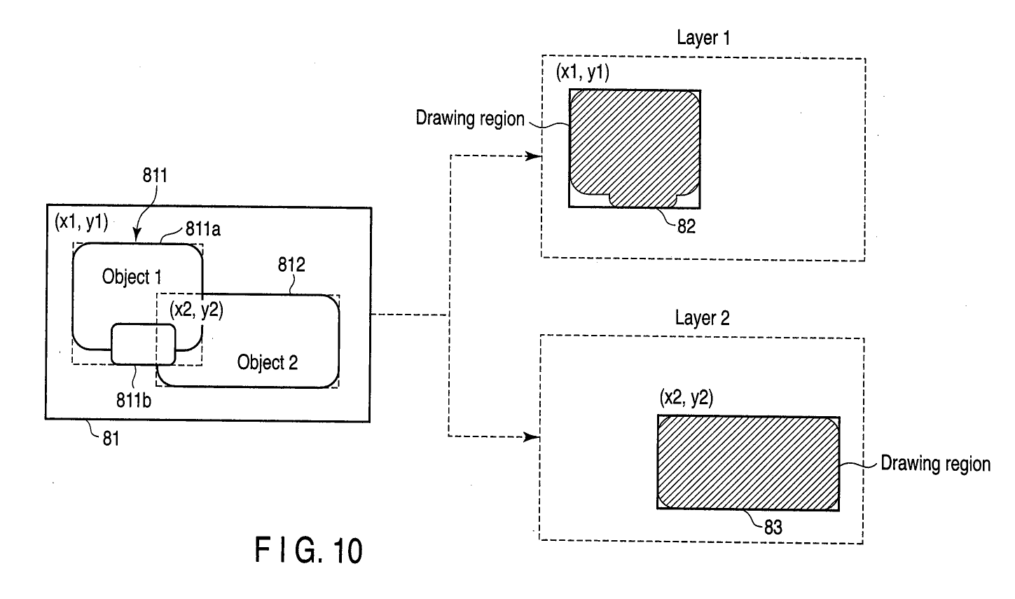

Note that a layer generated by the local terminal 1 may be set to have a size equal to a circumscribed rectangle of an object in place of the same size as the screen image, and the layer size may be changed in correspondence with a change in drawing region corresponding to the object. FIG. 10 shows an example of layers set to have the same sizes as circumscribed rectangles of objects.

Referring to FIG. 10, objects 811 and 812 are drawn on a screen image 81. The object 811 includes sub-objects 811a and 811b. For example, on the screen image 81, the sub-object 811a as a window of an application program, the sub-object 811b as a dialog, and the object 812 as a window of another application program are drawn.

As a layer on which the object 811 is drawn and that on which the object 812 is drawn, a layer 82 as a circumscribed rectangle of the object 811, and a layer 83 as a circumscribed rectangle of the object 812 are set respectively. The layers 82 and 83 are respectively set to have coordinates (x1, y1) and coordinates (x2, y2) indicating the display positions on the screen of the display device 5. The local terminal 1 displays the layers at the same positions as those of drawing regions on the screen image using the coordinates set in the respective layers.

By setting each layer to have the same size as a circumscribed rectangle of an object, a region to be assured as a layer can be smaller than the size of the screen image.

As described above, according to this embodiment, screen data transmitted from the remote terminal can be handled for respective objects. Since the local terminal generates layers for respective objects based on the screen image, object drawing region data, and object overlapping order data as screen data transmitted from the remote terminal, it can manage control of displays and manipulations of respective objects. When one remote terminal is connected, the local terminal can display, on its screen, for example, objects on the remote desktop screen of the remote terminal and a window on its desktop to overlap each other so as to sandwich the window between the objects on the remote desktop screen. When a plurality of remote terminals are connected, the local terminal can display, on its screen, for example, objects on the remote desktop screen of a certain remote terminal and a window included in a screen image from another remote terminal to overlap each other so as to sandwich the window between the objects on the remote desktop screen. That is, the local terminal can change the layouts of objects such as windows on the remote desktop screen for respective objects. Therefore, the local terminal allows the user to manipulate each individual object, and transmits manipulation data to that object to the remote terminal corresponding to the object. The remote terminal updates the screen image based on the received control data, and further transmits screen data based on the updated screen image to the local terminal, thereby updating the screen image in the local terminal.

When objects of remote terminals are displayed on the screen of the local terminal, the local terminal may manage the object overlapping order by holding data indicating an active object (focused object) in addition to the object overlapping order data for each remote terminal.

The description of this embodiment has been given mainly under the assumption that computers such as personal computers or workstations are used as the remote terminals and local terminal. Also, an embodiment in which a remote dedicated terminal manipulates screen data generated by an embedded device of an electric appliance can be achieved by the same method.

For example, when a television is used as a local terminal, and a personal computer is used as a remote terminal, a window of an application program as an object on the personal computer is displayed on the screen of the television. Since only the required window region of the application program can be displayed in place of the full screen of the personal computer, it does not disturb television viewing.

The information processing system of this embodiment can be constructed by expanding a normal thin-client protocol. For this reason, a communication protocol and programs used in the local and remote terminals can be created by greatly smaller man-hours than scratch development. That is, by expanding the mechanism of a normal remote desktop or the like, an information processing system in which a local terminal can flexibly manipulate objects on a remote terminal can be implemented.

The procedure of the remote desktop connection processing of this embodiment can be fully implemented by software. For this reason, by only installing a program that implements the procedure of the remote desktop connection processing in a normal computer via a computer-readable storage medium, the same effects as in this embodiment can be easily achieved.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing system comprising:
at least one remote apparatus configured to transmit a screen image on which objects are drawn, and drawing region data which indicates a region on the screen image where each of the objects is drawn; and
a local terminal connected to the at least one remote apparatus via a network and configured to receive the screen image and the drawing region data from the at least one remote apparatus, to extract images corresponding to the objects from the received screen image based on the received drawing region data, and to display the extracted images of the objects on a display screen.

2. The system of claim 1, wherein the at least one remote apparatus is configured to draw the objects on the screen image to overlap each other, and to transmit overlapping order data indicating an order of overlapping of the objects to the local terminal, and the local terminal is configured to overlay the extracted images of the objects in the order of overlapping indicated by the overlapping order data on the display screen.

3. The system of claim 2, wherein the local terminal is configured to draw the extracted objects on layers, and to overlay the layers in the order of overlapping indicated by the overlapping order data on the display screen.

4. The system of claim 1, which further comprises:
an input device connected to the local terminal and configured to manipulate the objects displayed on the display screen respectively,
in which the local terminal is configured to transmit manipulation data to the objects input from the input device to the at least one remote apparatus, and
the at least one remote apparatus is configured to change the screen image based on the manipulation data from the local terminal, and to transmit the changed screen image and drawing region data based on the changed screen image to the local terminal.

5. The system of claim 4, wherein the local terminal is configured to receive the changed screen image and the drawing region data based on the changed screen image from the at least one remote apparatus, to extract images corresponding to the objects from the received screen image based on the received drawing region data, and to display the extracted images of the objects on the display screen.

6. The system of claim 1, wherein the remote apparatus is configured to transmit a difference screen image between a changed screen image and the screen image before change, and difference drawing region data between drawing region data based on the changed screen image and the drawing region data before change to the local terminal when the screen image is changed by the at least one remote apparatus and
the local terminal is configured to receive the difference screen image and the difference drawing region data, to calculate a current screen image based on the difference screen image and the screen image received before change, to calculate current drawing region data based on the difference drawing region data and the drawing region data received before change, to extract images corresponding to the objects from the current screen image based on the current drawing region data, and to display the extracted images of the objects on the display screen.

7. An information processing apparatus comprising:
a reception module configured to receive a screen image on which objects are drawn, and drawing region data indicating a region on the screen image where each of the objects is drawn from at least one remote apparatus;
an object extraction module configured to extract images corresponding to the objects from the received screen image based on the received drawing region data; and
a display processing module configured to display the extracted images of the objects on a display screen.

8. A display control method of displaying screen image data of at least one remote apparatus on a display screen of a local terminal, comprising:
receiving a screen image of the at least one remote apparatus on which objects are drawn, and drawing region data indicating a region on the screen image where each of the objects is drawn, which are transmitted from the at least one remote apparatus;
extracting images corresponding to the objects from the screen image based on the drawing region data; and
displaying the extracted images of the objects on the display screen of the local terminal.
